(19) United States
(12) Patent Application Publication
(10) Pub. No.: US 2025/0390036 A1
(43) Pub. Date: Dec. 25, 2025

(54) OPTICAL SCANNING DEVICE AND IMAGE FORMING APPARATUS INCLUDING SAME

(71) Applicant: KYOCERA Document Solutions Inc., Osaka (JP)

(72) Inventor: Shingo YOSHIDA, Osaka (JP)

(73) Assignee: KYOCERA Document Solutions Inc., Osaka (JP)

(21) Appl. No.: 19/237,983

(22) Filed: Jun. 13, 2025

(30) Foreign Application Priority Data
Jun. 19, 2024 (JP) 2024-098963

(51) Int. Cl. G03G 15/043; G03G 15/02; G03G 15/04

(52) U.S. Cl. CPC G03G 15/0435; G03G 15/0258; G03G 15/04072; G03G 2215/0404

(57) ABSTRACT

An optical scanning device includes a casing, a transmissive member, a linear member, a drive portion, a plurality of first guide rails, a plurality of second guide rails, at least one cleaning holder, a cleaning member, and a stopper. The casing includes a rib formed along a peripheral edge part of an upper surface of the casing and a void section formed between the rib and an end part of the first guide rails on a side of the second direction. The cleaning holder includes a first restriction portion that engages with the first guide rails in an up-down direction and a second restriction portion that is in contact with a side surface of the second guide rails.

### INCORPORATION BY REFERENCE

This application is based on and claims the benefit of priority from Japanese Patent Application No. 2024-98963 filed on Jun. 19, 2024, the contents of which are hereby incorporated by reference.

### BACKGROUND

The present disclosure relates to an optical scanning device incorporated in an electrophotographic image forming apparatus so as to irradiate an image carrier with light to thereby form an electrostatic latent image, and also relates to an image forming apparatus including the optical scanning device.

An optical scanning device irradiates a charged image carrier with light to thereby form an electrostatic latent image on the image carrier. A known configuration of optical scanning devices includes a casing, a transmissive member, a linear member, a drive member, a guide rail, a cleaning holder, a cleaning member, and a stopper. The cleaning member needs to be replaced with a new one after being used for a predetermined period of time, and thus it is necessary to improve workability in attaching and detaching the cleaning member.

### SUMMARY

According to one aspect of the present disclosure, an optical scanning device irradiates an image carrier with laser light to thereby form an electrostatic latent image on the image carrier.

The optical scanning device includes a casing, a transmissive member, a linear member, a drive portion, a plurality of first guide rails, a plurality of second guide rails, at least one cleaning holder, a cleaning member, and a stopper. In the casing, an emission port for the laser light is formed corresponding to the image carrier so as to extend in a main scanning direction of the laser light. The transmissive member has transmissivity with respect to the laser light, extends in the main scanning direction of the laser light, and seals the emission port for the laser light. The linear member is stretched in a loop on the casing. The drive portion drives the linear member to travel in a predetermined direction. The plurality of first guide rails are formed on an upper surface of the casing and extend in an extension direction of the transmissive member. The plurality of second guide rails are formed on the upper surface of the casing and extend parallel to the first guide rails. The cleaning holder is fixed to the linear member and moves on the transmissive member along the first guide rails and the second guide rails in a first direction and in a second direction that is opposite to the first direction when the linear member is driven to travel by the drive portion. The cleaning member is fixed to the cleaning holder and slides with respect to the transmissive member along with movement of the cleaning holder to thereby clean the transmissive member. The stopper is formed at an end part of the first guide rails on a side of the first direction, and restricts movement of the cleaning holder in the first direction. The cleaning holder includes a first restriction portion that engages with the first guide rails in an up-down direction to thereby restrict upward movement of the cleaning holder, and a second restriction portion that is in contact with a side surface of the second guide rails to thereby restrict rotation of the cleaning holder. The casing includes a rib formed along a peripheral edge part of the upper surface of the casing and a void section that is formed between the rib and an end part of the first guide rails on a side of the second direction and that allows engagement between the first guide rails and the first restriction portion to be released therethrough.

### BRIEF DESCRIPTION OF THE DRAWINGS

FIG. 1 is a sectional view schematically showing an overall configuration of an image forming apparatus 1 incorporating an optical scanning device of the present disclosure.

FIG. 2 is a perspective view of an optical scanning device according to one embodiment of the present disclosure.

FIG. 3 is a plan view of the optical scanning device of the present embodiment as seen from above.

FIG. 4 is a sectional view of a mounting section for mounting a cleaning holder in a cover portion of the optical scanning device according to the present embodiment, as seen from a movement direction of the cleaning holder.

FIG. 5 is a sectional view of the cleaning holder mounted on the cover portion of the optical scanning device according to the present embodiment, as seen from the movement direction of the cleaning holder.

FIG. 6 is a partial perspective view of the cover portion of the optical scanning device according to the present embodiment, illustrating an area around an end part of one first guide rail to which the cleaning holder is coupled on a side of a detection portion.

FIG. 7 is a partial perspective view of the cover portion of the optical scanning device according to the present embodiment, illustrating an area around an end part of another first guide rail to which the cleaning holder is coupled on the side of the detection portion.

FIG. 8 is a plan view of the optical scanning device of the present embodiment, illustrating a state in which the cleaning holder has been detected by the detection portion.

FIG. 9 is a plan view of the optical scanning device of the present embodiment, illustrating a state in which a cleaning holder has been detected by the detection portion.

FIG. 10 is a block diagram showing an example of a control path used in the image forming apparatus.

FIG. 11 is a partial plan view of an X2-side end part of the optical scanning device of the present embodiment as seen from above.

FIG. 12 is a partial plan view of the X2-side end part of the optical scanning device according to the present embodiment as seen from above, showing a state in which the cleaning holder has stopped at X2-side end parts of the first guide rails.

FIG. 13 is a diagram showing a state in which the cleaning holder has started to move from the state shown in FIG. 12 toward an X1 side of the first guide rails.

FIG. 14 is a schematic diagram showing a configuration in which second restriction portions of the cleaning holder abut outer sides of second guide rails.

FIG. 15 is a diagram showing a state in which, in the configuration of FIG. 14, a clockwise rotational moment is generated about point P1 when the cleaning holder is moved in an X2 direction.

FIG. 16 is a diagram showing a state in which a counterclockwise rotational moment is generated about point P2 when the cleaning holder is moved farther in the X2 direction from the state shown in FIG. 15.

FIG. 17 is a schematic diagram showing a configuration in which the second restriction portions of the cleaning holder abut an inner sides of the second guide rails.

FIG. 18 is a diagram showing a state in which, in the configuration of FIG. 17, a clockwise rotational moment is generated about point P3 when the cleaning holder is moved in the X2 direction.

FIG. 19 is a diagram showing a state in which a counterclockwise rotational moment is generated about point P4 when the cleaning holder is moved farther in the X2 direction from the state shown in FIG. 18.

FIG. 20 is a partial enlarged view of and around a cleaning member on one side of the cleaning holder shown in FIG. 5.

FIG. 21 is a partial enlarged view of and around a cleaning member 53 on the other side of the cleaning holder shown in FIG. 5.

FIG. 22 is a partial plan view of the X2-side end part of the optical scanning device according to the present embodiment, showing a state in which the cleaning holders have stopped at the X2-side end parts of the first guide rails.

FIG. 23 is a diagram showing a state in which, from the state shown in FIG. 22, pulleys on the X2 side of the optical scanning device have been detached and the cleaning holders have been moved in the X2 direction.

### DETAILED DESCRIPTION

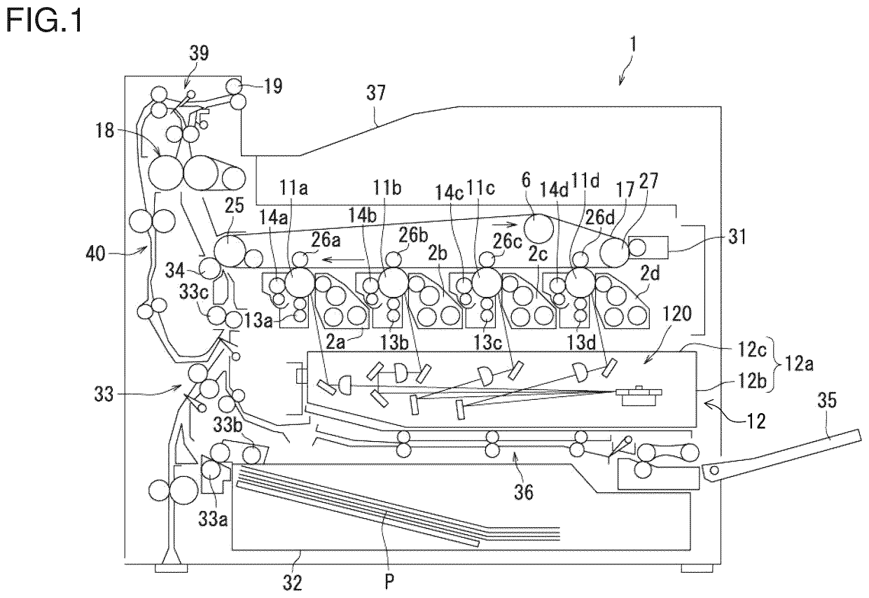

Hereinafter, an embodiment of the present disclosure will be described with reference to the accompanying drawings. FIG. 1 is a sectional view schematically showing an overall configuration of an image forming apparatus 1 incorporating an optical scanning device 12 of the present disclosure. The image forming apparatus 1 is a tandem-type color printer. The image forming apparatus 1 includes photosensitive drums 11a to 11d, which are rotatable, as image carriers. Each of the photosensitive drums 11a to 11d is formed of, for example, an organic photosensitive member (an OPC photosensitive member) on which an organic photosensitive layer is formed, or an amorphous silicon photosensitive member on which an amorphous silicon photosensitive layer is formed. The photosensitive drums 11a to 11d are arranged in a tandem manner respectively corresponding to colors of yellow, magenta, cyan, and black.

Around the photosensitive drum 11a, a developing device 2a, a charger 13a, and a cleaning device 14a are arranged. Likewise, developing devices 2b to 2d, chargers 13b to 13d, and cleaning devices 14b to 14d are respectively arranged around the photosensitive drums 11b to 11d.

Moreover, below the developing devices 2a to 2d, an optical scanning device 12 is arranged.

The developing devices 2a to 2d are each disposed on a right side of a corresponding one of the photosensitive drums 11a to 11d. The developing devices 2a to 2d each face a corresponding one of the photosensitive drums 11a to 11d, and each supply toner to the corresponding one of the photosensitive drums 11a to 11d. Note that the terms “right” and “left” respectively refer to right and left in the drawings.

The chargers 13a to 13d are each disposed upstream of a corresponding one of the developing devices 2a to 2d with respect to a rotation direction of the corresponding one of the photosensitive drums 11a to 11d, and are each opposed to a surface of the corresponding one of the photosensitive drums 11a to 11d. The chargers 13a to 13d each uniformly charge the surface of the corresponding one of the photosensitive drums 11a to 11d.

Based on image data such as letters and patterns fed from a personal computer or the like to an image input portion (unillustrated), the optical scanning device 12 irradiates with light (optically scans), the surfaces of the photosensitive drums 11a to 11d having been uniformly charged by the chargers 13a to 13d, thereby forming electrostatic latent images on the surfaces of the photosensitive drums 11a to 11d.

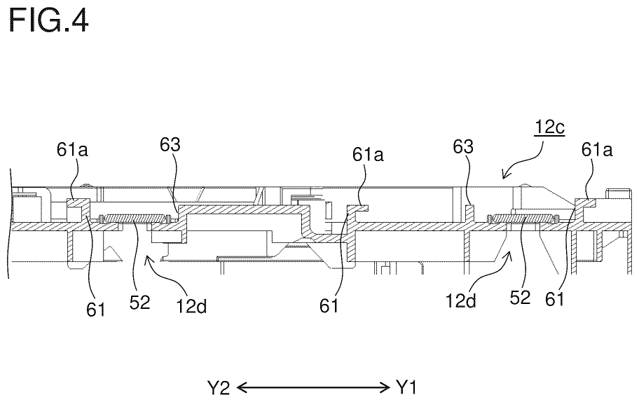

The optical scanning device 12 has a casing 12a that includes a housing portion 12b having an opening in one surface thereof and a cover portion 12c that covers the opening. The housing portion 12b incorporates therein a scanning optical system 120. The cover portion 12c has formed therein emission ports 12d (see FIG. 4) for light (laser light) emitted from the scanning optical system 120, each of the emission ports 12d corresponding to one of the photosensitive drums 11a to 11d. Furthermore, as will be described later, the emission ports 12d are each covered with one of transmissive members 52. The transmissive members 52 have transmissivity with respect to the light emitted from the scanning optical system 120.

The scanning optical system 120 includes a laser light source and a polygon mirror. The scanning optical system 120 further includes at least one reflection mirror and a lens (of which none is illustrated) corresponding to each of the photosensitive drums 11a to 11d. The laser light emitted from the laser light source is applied, via the polygon mirror, the reflection mirrors, and the lenses, to the surface of each of the photosensitive drums Ila to 11d from a downstream side of a corresponding one of the chargers 13a to 13d with respect to the rotation direction of the corresponding one of the photosensitive drums 11a to 11d. Thereby, electrostatic latent images are formed on the surfaces of the photosensitive drums 11a to 11d. These electrostatic latent images are developed into toner images by the developing devices 2a to 2d.

An intermediate transfer belt 17, which is an endless belt, is stretched around a tension roller 6, a driving roller 25, and a driven roller 27. The driving roller 25 is caused by a motor (unillustrated) to rotate, and thereby drives the intermediate transfer belt 17 to circulate in a clockwise direction in FIG. 1.

The photosensitive drums 11a to 11d are arrayed below the intermediate transfer belt 17 so as to be adjacent to each other along a conveyance direction (an arrow direction in FIG. 1). The photosensitive drums 11a to 11d are each in contact with the intermediate transfer belt 17. Primary transfer rollers 26a to 26d are each opposed to a corresponding one of the photosensitive drums 11a to 11d via the intermediate transfer belt 17. The primary transfer rollers 26a to 26d are pressed against the intermediate transfer belt 17 to form primary transfer portions together with the photosensitive drums 11a to 11d, respectively. In these primary transfer portions, the toner images are transferred to the intermediate transfer belt 17. Specifically, a primary transfer voltage is applied to each of the primary transfer rollers 26a to 26d, and thereby the toner images on the photosensitive drums 11a to 11d are sequentially transferred onto the intermediate transfer belt 17 with predetermined timing. Thereby, on a surface of the intermediate transfer belt 17, a full-color toner image is formed in which the toner images of four colors of yellow, magenta, cyan, and black are superimposed on each other in a predetermined positional relationship.

A secondary transfer roller 34 is opposed to the driving roller 25 via the intermediate transfer belt 17. The secondary transfer roller 34 is pressed against the intermediate transfer belt 17 to form a secondary transfer portion together with the driving roller 25. In this secondary transfer portion, a secondary transfer voltage is applied to the secondary transfer roller 34, and thereby the toner image on the surface of the intermediate transfer belt 17 is transferred onto a sheet P. After the transfer of the toner image, a belt cleaning device 31 cleans residual toner off the intermediate transfer belt 17.

Inside the image forming apparatus 1, in a lower part, a sheet feed cassette 32 is disposed. The sheet feed cassette 32 accommodates a plurality of sheets P. On a right side of the sheet feed cassette 32, a stack tray 35 is disposed for manual sheet feeding. On a left side of the sheet feed cassette 32, a first sheet conveyance path 33 is disposed. The first sheet conveyance path 33 conveys a sheet P fed out from the sheet feed cassette 32 to the secondary transfer portion.

Further, on a left side of the stack tray 35, a second sheet conveyance path 36 is disposed. The second sheet conveyance path 36 conveys a sheet fed out from the stack tray 35 to the secondary transfer portion. Moreover, in an upper left part of the image forming apparatus 1, a fixing portion 18 and a third sheet conveyance path 39 are disposed. The fixing portion 18 performs a fixing process with respect to a sheet P having an image formed thereon. The third sheet conveyance path 39 conveys the sheet P having been subjected to the fixing process to a sheet discharge portion 37.

Sheets P stacked in the sheet feed cassette 32 is fed out one by one by a pick-up roller 33b and a separation roller pair 33a toward the first sheet conveyance path 33.

The first sheet conveyance path 33 and the second sheet conveyance path 36 join together before reaching a registration roller pair 33c (on an upstream side thereof). The registration roller pair 33c conveys a sheet P to the secondary transfer portion with timing coordinated with an image forming operation performed on the intermediate transfer belt 17 and the sheet feeding operation to the secondary transfer portion. With respect to the sheet P having been conveyed to the secondary transfer portion, by the secondary transfer roller 34 to which the secondary transfer voltage has been applied, the full-color toner image, which has been formed on the intermediate transfer belt 17, is secondarily transferred. The sheet P having the full-color toner image transferred thereon is conveyed to the fixing portion 18.

The fixing portion 18 includes a fixing belt that is heated by a heater, a fixing roller that is internally in contact with the fixing belt, a pressing roller that is pressed against the fixing roller with the fixing belt therebetween, etc. The fixing portion 18 applies heat and pressure to the sheet P having the toner image transferred thereon. In this manner, the fixing process is carried out. The sheet P having the toner image fixed thereon in the fixing portion 18 is turned upside down, as necessary, through a fourth sheet conveyance path 40. Thereafter, the sheet P is conveyed again to the secondary transfer portion via the registration roller pair 33c, and then a new toner image is secondarily transferred onto a back side of the sheet P by the secondary transfer roller 34, and is then fixed in the fixing portion 18. The sheet P having the toner image fixed thereon passes through the third sheet conveyance path 39 to be discharged by a discharge roller pair 19 into the sheet discharge portion 37.

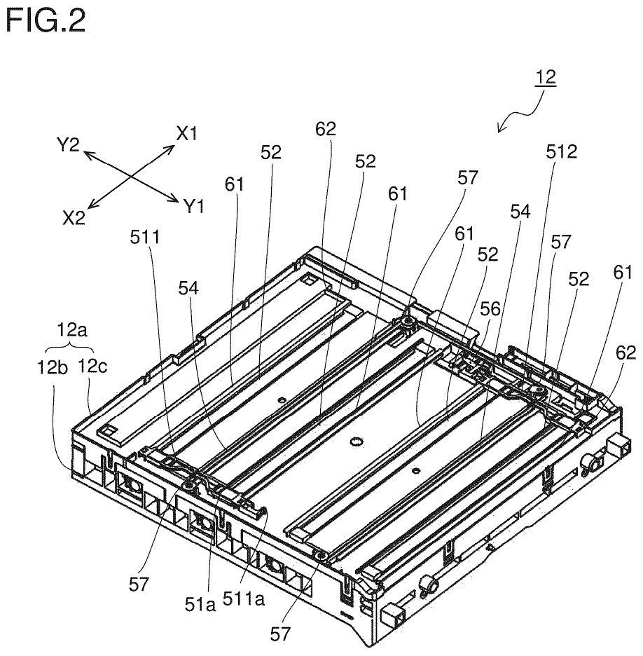

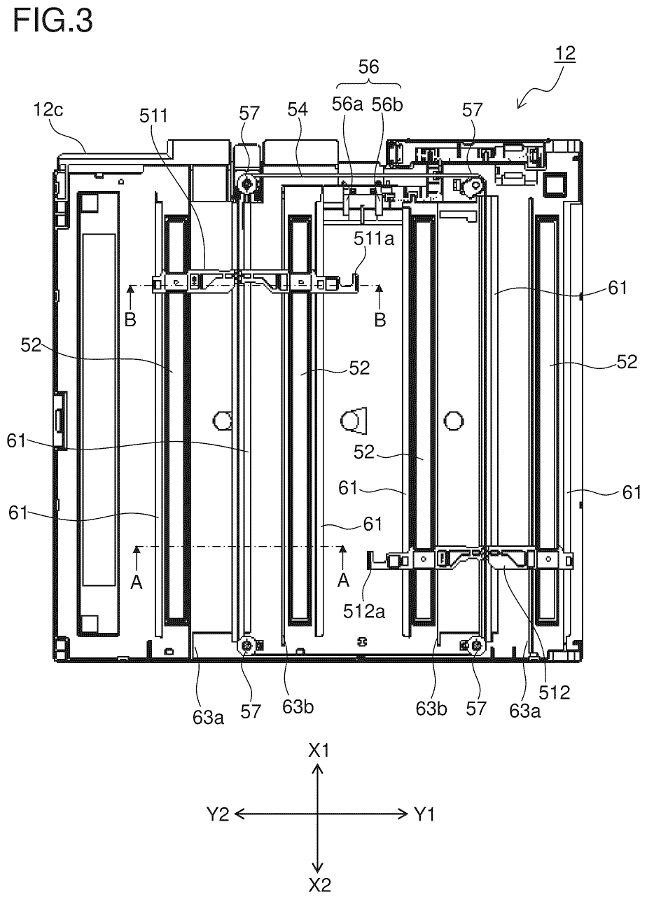

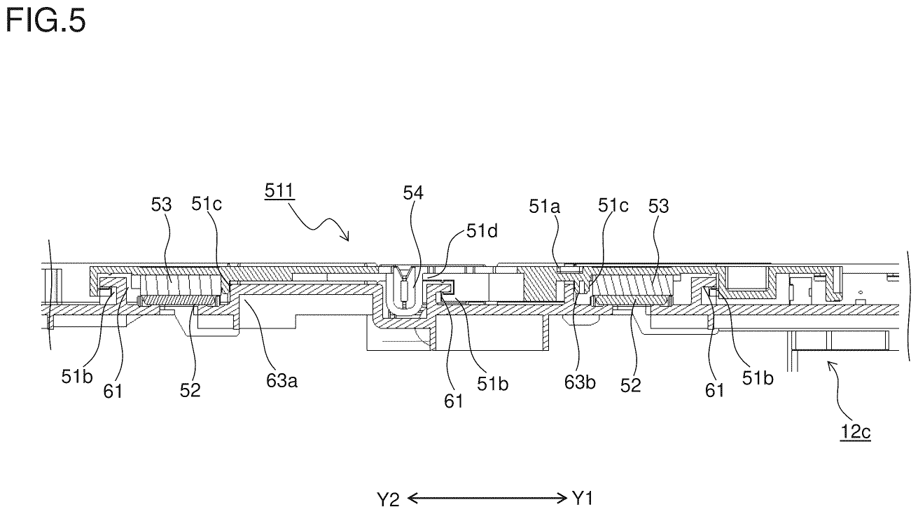

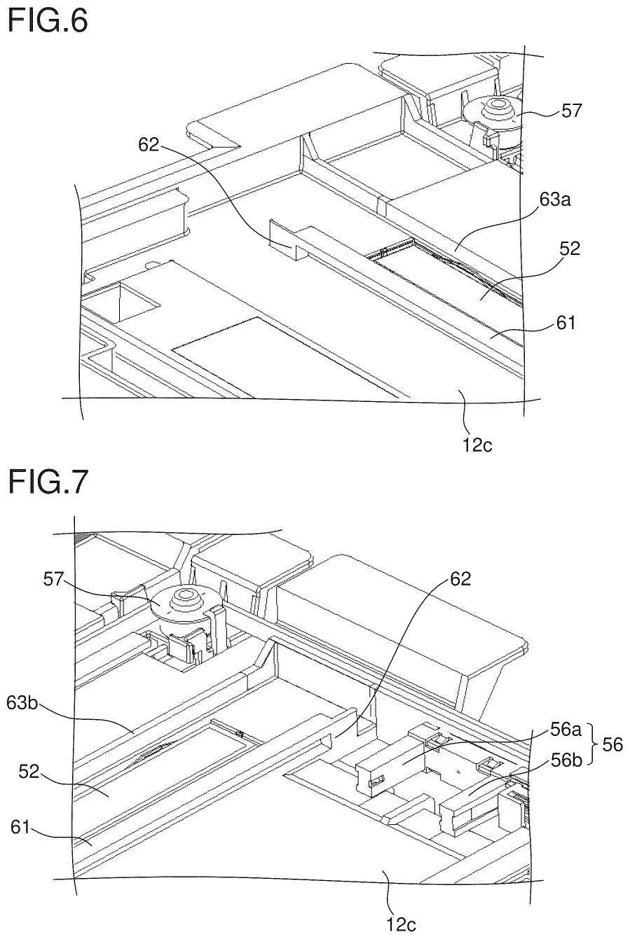

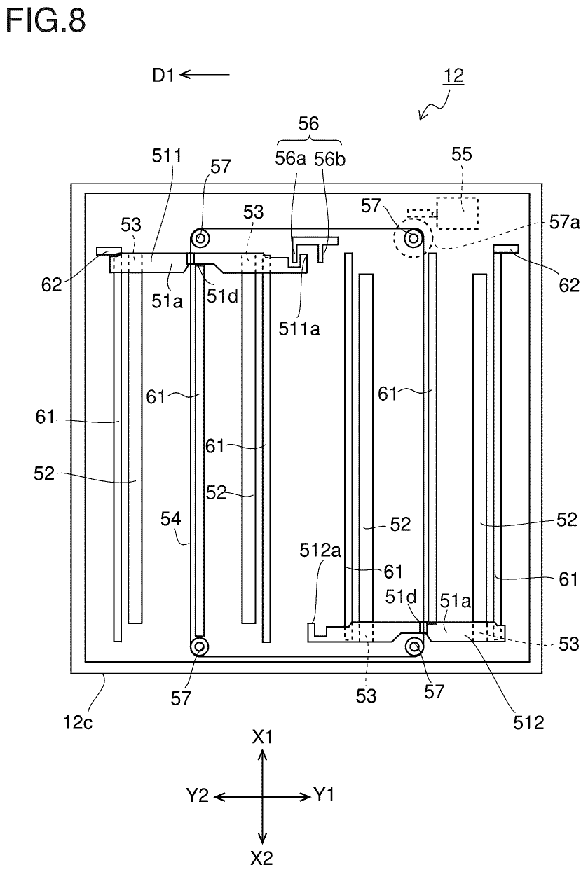

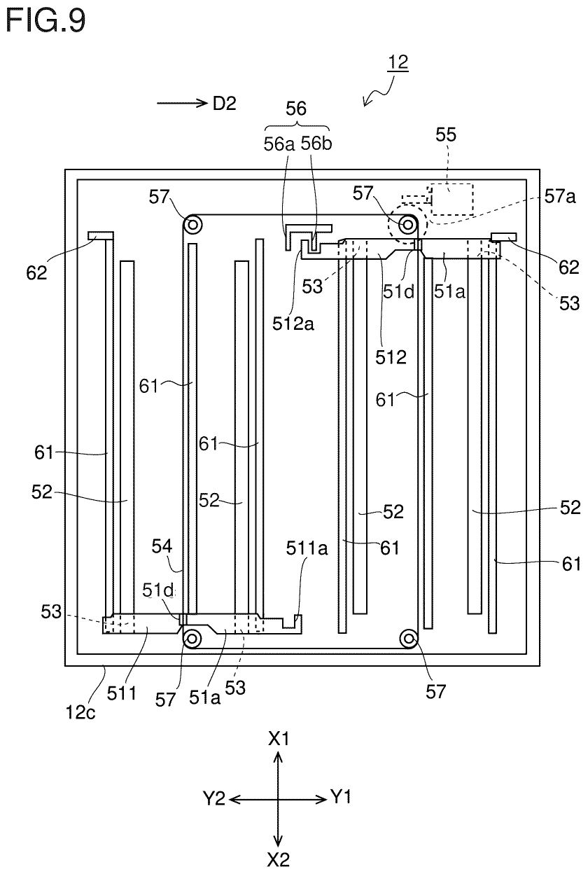

Next, with reference to FIGS. 2 to 9, a description will be given of the optical scanning device 12. FIG. 2 is a perspective view of the optical scanning device 12 according to one embodiment of the present disclosure. FIG. 3 is a plan view of the optical scanning device 12 of the present embodiment as seen from above. FIGS. 4 and 5 are sectional views that respectively depict a mounting section for a cleaning holder 511 in the cover portion 12c of the optical scanning device 12 according to the present embodiment, and the cleaning holder 511 mounted on the cover portion 12c, both as seen from a movement direction of the cleaning holder 511. FIGS. 6 and 7 are partial perspective views of areas around end parts respectively of one and the other first guide rails 61 to which the cleaning holder 511 is coupled on a side of the detection portion 56. FIGS. 8 and 9 are plan views of the optical scanning device 12. Note that, in FIGS. 8 and 9, illustration of second guide rails 63a and 63b is omitted.

Note that, in the drawings referred to below, an extension direction of the transmissive members 52 will be referred to as an X direction, an X1 direction (a first direction) being a direction in which the cleaning holders 511 and 512 approach the detection portion 56, an X2 direction (a second direction) being a direction in which the cleaning holders 511 and 512 move away from the detection portion 56. A parallel alignment direction of the transmissive members 52 (a longitudinal direction of the cleaning holders 511 and 512) in which the transmissive members 52 are arranged side by side to be parallel to each other will be referred to as a Y direction, Y1 denoting one side in the parallel alignment direction of the transmissive members 52, Y2 denoting the other side in the parallel alignment direction of the transmissive members 52. In describing shapes of various components and a positional relationship among them, it is assumed that the cleaning holders 511 and 512 are positioned above the cover portion 12c. Here, an up-down direction is a term used simply for description, and does not limit directions when the optical scanning device 12 is installed in the image forming apparatus 1.

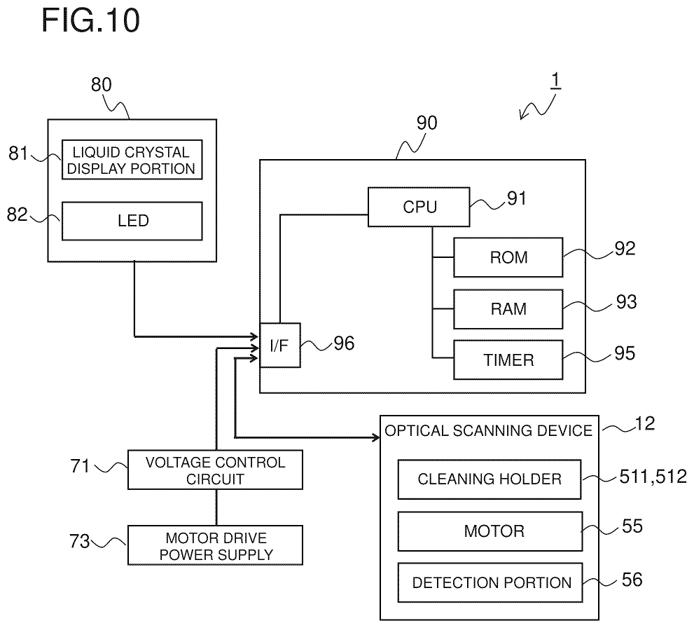

The optical scanning device 12 includes the casing 12a, the transmissive members 52, a linear member 54, a motor (a drive portion) 55, the first guide rails 61, stoppers 62, the second guide rails 63, the cleaning holders 511 and 512, cleaning members 53, the detection portion 56, and a control portion 90 (see FIG. 10).

As shown in FIG. 2, the casing 12a includes the housing portion 12b and the cover portion 12c covering the housing portion 12b. In the cover portion 12c, corresponding to the four photosensitive drums 11a to 11d, four emission ports 12d (see FIG. 4) for laser light are provided to be arranged side by side. The emission ports 12d each have a rectangular shape elongated in the scanning direction of the corresponding laser light (the X direction), and the emission ports 12d are formed such that their longitudinal directions (the X direction) are parallel to each other.

The transmissive members 52 are formed in a rectangular plate shape, sealing the emission ports 12d. This makes it possible to prevent entry of toner, dust, and the like into the optical scanning device 12 through the emission ports 12d. The four transmissive members 52 are arranged side by side such that their longitudinal directions (the X direction) are parallel to each other. Each of the transmissive members 52 is a glass cover, for example.

As shown in FIGS. 3 and 4, two of the first guide rails 61 are disposed on opposite sides, with a pair of the transmissive members 52 disposed therebetween, and furthermore, another one of the first guide rails 61 is disposed between the pair of the transmissive members 52. That is, three first guide rails 61 are provided corresponding to each of the cleaning holders 511 and 512, such that a total of six first guide rails 61 are arranged side by side. The first guide rails 61 protrude from an upper surface of the cover portion 12c and extend along the extension direction (the X direction) of the transmissive members 52. The first guide rails 61 have guide ribs 61a (see FIG. 4) respectively protruding horizontally from leading end parts thereof.

As shown in FIGS. 6 and 7, the stoppers 62 are provided one with respect to the three first guide rails 61 over which each of the cleaning holders 511 and 512 crosses, such that each of the stoppers 62 is integrally formed with a one-side (X1-side) end part of one of the two first guide rails 61 that are disposed on the opposite end sides in the parallel alignment direction (the Y direction). The stoppers 62 restrict movement of the cleaning holders 511 and 512 toward one side (the X1 side) in the extension direction.

As the second guide rails 63, two second guide rails 63a and 63b are provided one between each pair of adjacent ones of the three first guide rails 61, such that a total of four second guide rails 63a and 63b are arranged side by side. The second guide rails 63a and 63b protrude from the upper surface of the cover portion 12c and extend in the extension direction of the transmissive members 52 (the X direction). As shown in FIG. 3, the second guide rails 63a are each formed outward of the linear member 54, which is stretched in a loop. The second guide rails 63b are formed inside the linear member 54, which is stretched in a loop.

As shown in FIG. 5, the cleaning holders 511 and 512 are disposed on the upper surface of the cover portion 12c (a surface opposite to the photosensitive drums 11a to 11d). The cleaning holders 511 and 512 each include a main body portion 51a, a first restriction portion 51b, a second restriction portion 51c, and a recessed portion 51d. The main body portion 51a is formed in a plate shape elongated in the parallel alignment direction of the transmissive members 52 (the Y direction), and disposed so as to cross over a space between each pair of adjacent ones of the transmissive members 52.

The cleaning members 53 are fixed to a lower surface of the main body portion 51a. The cleaning members 53 are arranged in pairs, at positions opposite to the transmissive members 52 in the parallel alignment direction (the Y direction). Along with travel of the linear member 54 in a loop, the cleaning members 53 slide along upper surfaces (surfaces on a side of the photosensitive drums 11a to 11d) of the transmissive members 52 in the X direction. Thereby, the upper surfaces of the transmissive members 52 are cleaned simultaneously, each by a corresponding one of the cleaning members 53.

The cleaning members 53 are each a rubber pad, for example. A material usable for the rubber pads is a silicone rubber, for example. The cleaning holders 511 and 512 are each formed of a resin, for example. Note that the cleaning members 53 are not limited to a rubber pad, and may instead be made of a non-woven fabric, for example.

The first restriction portion 51b is formed on a lower surface of the main body portion 51a at each of three positions corresponding to the three first guide rails 61. The first restriction portions 51b each project downward from the lower surface of the main body portion 51a, with a leading end part thereof bent toward a corresponding one of the first guide rails 61. The first restriction portions 51b each engage with the guide rib 61a of the corresponding one of the first guide rails 61.

Thereby, opposite end parts of the main body portion 51a are locked by the first guide rails 61 in a direction (an upward direction in FIG. 5) away from the casing 12a of the optical scanning device 12. The cleaning holders 511 and 512 are restricted in movement (positional displacement) in the upward direction, and thus can be prevented from coming off the cover portion 12c. Thus, it is possible to stably keep the cleaning members 53 in close contact with the transmissive members 52.

Further, in the present embodiment, with respect to each of the cleaning holders 511 and 512, three first guide rails 61 are provided one opposite to each of the opposite end parts, and a part around a center, of the main body portion 51a in a longitudinal direction thereof, and the first restriction portions 51b are provided one at each of three positions in the opposite end parts, and the part around the center, of the main body portion 51a, so as to engage with the guide ribs 61a of the three first guide rails 61. According to this configuration, it is possible to prevent lift of the part around the center of the main body portion 51a, the linear member 54 being fixed at the part, and thus to further improve contact tightness between the cleaning members 53 and the transmissive members 52.

The second restriction portion 51c is formed on the lower surface of the main body portion 51a at each of two positions corresponding to two second guide rails 63a and 63b. The second restriction portions 51c are in contact with, or opposite across a predetermined distance to, side surfaces of the two second guide rails 63a and 63b, from outside in the parallel alignment direction (the Y direction). Thereby, horizontal rotation of the main body portion 51a is restricted. As a result, the cleaning holders 511 and 512 are allowed to be positioned perpendicular to the X direction, and thus to reciprocate stably on the transmissive members 52 in the extension direction (the X direction).

The main body portion 51a includes the recessed portion 51d that is recessed downward from the upper surface thereof. Inside the recessed portion 51d, the linear member 54 is fixed. Note that the recessed portion 51d may be formed to be recessed upward from the lower surface of the main body portion 51a.

The cleaning holders 511 and 512 respectively include a first light blocking portion 511a and a second light blocking portion 512a. The first light blocking portion 511a is disposed, in the cleaning holder 511, at a side end part of the main body portion 51a on one side (the Y1 side) in the parallel alignment direction, and protrudes toward one side (the X1 direction) in the extension direction. The second light blocking portion 512a is disposed, in the cleaning holder 512, at a side end part of the main body portion 51a on the other side (the Y2 side) in the parallel alignment direction, and protrudes toward one side (the X1 direction) in the extension direction (see FIGS. 8 and 9). The first light blocking portion 511a and the second light blocking portion 512a have mutually different shapes. For example, the first light blocking portion 511a does not have a through hole, whereas the second light blocking portion 512a has a through hole.

The linear member 54 is a timing belt or a wire, for example. The linear member 54 is stretched in the casing 12a in a loop around four pulleys 57 so as to pass between each pair of the transmissive members 52. The linear member 54 extends between each pair of adjacent transmissive members 52 so as to be parallel to their extension direction (the X direction). The four pulleys 57 are rotatably held on the upper surface of the cover portion 12c.

Further, one of the pulleys 57 is coupled to a gear 57a disposed on the lower surface of the cover portion 12c (see FIGS. 8 and 9). The gear 57a is coupled to the motor 55. The motor 55 drives the gear 57a to rotate, thereby driving the linear member 54 to travel in a loop.

The motor (the drive portion) 55 is disposed outward of the linear member 54, and is also fixed to the lower surface of the cover portion 12c. That is, an upper end of the motor 55 is disposed below an upper end of the linear member 54. This arrangement helps save space on the upper surface of the cover portion 12c. Further, by disposing the motor 55 outward of the linear member 54, it is possible to achieve improved workability in maintenance of the motor 55 and the gear 57a. The motor 55 is rotatable both forward and backward directions, and drives the linear member 54 to travel, in top view, in a loop in a clockwise direction (a D2 direction) or in a counterclockwise direction (a D1 direction) (see FIGS. 8 and 9). Thereby, the cleaning holders 511 and 512 are caused to reciprocate along the longitudinal directions of the transmissive members 52 (the main scanning direction of the laser light). Further, during their reciprocation, the cleaning holder 511 and the cleaning holder 512 linearly move in mutually opposite directions.

Note that a cleaning process is executed, while the image forming apparatus 1 is in a maintenance mode, when a user inputs process starting instructions via an operation portion 80 (see FIG. 10) or a host device such as a personal computer. Further, the cleaning process may be executed regularly every time printing (image formation) is performed on, for example, about 10000 sheets.

The detection portion 56 is disposed on one side (the X1 side) in the extension direction of the transmissive members 52 so as to be disposed between a movement path of the cleaning holder 511 and a movement path of the cleaning holder 512 in the parallel alignment direction of the transmissive members 52 (in the Y direction) (see FIGS. 8 and 9). The detection portion 56 detects that one of the cleaning holders 511 and 512 has reached one end part of its movement path. Note that the cleaning holders 511 and 512, on reaching the one end part of its movement path, make contact with the stoppers 62, so that movement thereof toward the one side (the X1 side) in the extension direction is restricted.

The detection portion 56 is a transmissive optical sensor (a photo interrupter) that includes a light emitter 56a and a light receiver 56b, and is capable of detecting, with a single sensor, that the cleaning holder 511 or the cleaning holder 512 has reached the one end part of its movement path. The light emitter 56a emits light in the parallel alignment direction (the Y direction) of the transmissive members 52. The light receiver 56b receives light emitted from the light emitter 56a. Note that, although, in the present embodiment, the light emitter 56a is disposed more on the one side (the Y1 side) in the parallel alignment direction than the light receiver 56b is, the light emitter 56a may instead be disposed more on the other side (the Y2 side) in the parallel alignment direction than the light receiver 56b is.

The first light blocking portion 511a of the cleaning holder 511 and the second light blocking portion 512a of the cleaning holder 512 have mutually different shapes. This enables the detection portion 56 to detect, on the basis of the pattern of light received by the light receiver 56b, which of the cleaning holders 511 and 512 has reached the one end part of its movement path. Thus, it is possible to simplify the detection portion 56 to thereby reduce production cost of the optical scanning device 12.

Next, referring to FIGS. 8 and 9, operation of the cleaning holders 511 and 512 will be described. In the present embodiment, as described previously, during one execution of the cleaning process, a corresponding one of the cleaning members 53 reciprocates once along the extension direction of each of the transmissive members 52 (the X direction). The description here will deal with a case where, during the cleaning process, a travel direction of the linear member 54 is reversed from an arrow-D1 direction to an arrow-D2 direction.

At a start of the cleaning process, the cleaning holder 511 is located at one end of its movement path, causing the detection portion 56 to be in an ON state (see FIG. 8). By setting an initial position such that, at a start of an execution of a cleaning mode, the cleaning holder 511 is disposed at the one end part of its movement path, it is possible, with the detection portion 56 in the ON state, to detect the cleaning holder 511. This makes it possible to prevent the occurrence of an initial error in the cleaning process.

When the cleaning process is started, the linear member 54 travels in the arrow-D1 direction (see FIG. 8). Thereby, the cleaning holder 511 and the cleaning holder 512 are caused to move from their respective positions shown in FIG. 8 to their respective positions shown in FIG. 9, and the detection portion 56 detects that the cleaning holder 512 has reached the one end part of its movement path, and the linear member 54 is caused to stop travelling. As a result, the cleaning holder 511 and the cleaning holder 512 stop moving.

Next, the motor 55 starts to rotate reversely, so that the linear member 54 travels in the arrow-D2 direction (see FIG. 9). Thereby, the cleaning holder 511 and the cleaning holder 512 are caused to move from their respective positions shown in FIG. 9 to their respective positions shown in FIG. 8, and the detection portion 56 detects that the cleaning holder 511 has reached the one end part of its movement path, and causes the linear member 54 to stop travelling. As a result, the cleaning holder 511 and the cleaning holder 512 stop operating.

FIG. 10 is a block diagram showing one example of a control path used in the image forming apparatus 1. Note that the image forming apparatus 1 is used with various controls executed on its various portions, and this results in a complex control path of the entire image forming apparatus 1. Hence, the description here will focus on necessary part of the control path for implementation of the present disclosure.

A voltage control circuit 71, which is connected to a motor drive power supply 73, activates the motor drive power supply 73 based on an output signal from the control portion 90. The motor drive power supply 73, based on a control signal from the voltage control circuit 71, applies a predetermined drive voltage to the motor 55 disposed inside the optical scanning device 12.

In the operation portion 80, there are provided a liquid crystal display portion 81 and LEDs 82 that indicate various kinds of states, so as to indicate states of the image forming apparatus 1 and to display information such as conditions of image formation, how many sheets have been printed, and the like. Various settings for the image forming apparatus 1 are made via a printer driver of a personal computer.

The control portion 90 at least includes a CPU (central processing unit) 91 as a central processor, a ROM (read-only memory) 92 which is a read-only storage portion, a RAM (random access memory) 93 which is a readable/writable storage portion, a timer 95, and an I/F (interface) 96 that transmits a control signal to various devices in the image forming apparatus 1 and receives an input signal from the operation portion 80.

The ROM 92 stores therein a control program for the image forming apparatus 1, data that stays unchanged during use of the image forming apparatus 1, such as numerical values necessary for controlling the image forming apparatus 1, and the like. The RAM 93 stores therein necessary data generated during control of the image forming apparatus 1, data temporarily required for controlling the image forming apparatus 1, and the like. The RAM 93 (or the ROM 92) further stores therein, for example, a voltage value (DUTY) applied to the motor 55, a driving time of the motor 55 measured during cleaning of the transmissive members 52 of the optical scanning device 12, etc. The timer 95 measures the driving time of the motor 55.

According to the present embodiment, during the execution of the cleaning mode, when the detection portion 56 detects that one of the cleaning holders 511 and 512 has reached the one end part of its movement path, the linear member 54 is driven to start operation of traveling forward, while, when the detection portion 56 detects that the other of the cleaning holders 511 and 512 has reached the one end part of its movement path, the linear member 54 is driven to start operation of traveling backward. In other words, by having the control portion 90 determine the switching between the operation of traveling forward and the operation of traveling backward based on a detection result of the detection portion 56, it is possible to reduce load on the linear member 54 and to prevent the pulleys 57 from being damaged.

Further, by setting the initial position such that, at the start of the execution of the cleaning mode, the cleaning holder 511 is disposed at the one end part of its movement path, it is possible, with the detection portion 56 in the ON state, to detect the cleaning holder 511. This makes it possible to prevent the occurrence of an initial error in the cleaning process.

Further, on starting the execution of the cleaning mode, the control portion 90 determines, via the detection portion 56, which of the cleaning holders 511 and 512 is located at the one end part of its movement path, and decides which of the operation of forward travel and the operation of backward travel is to be started. This enables a quick start-up of the cleaning operation no matter which of the cleaning holders 511 and 512 may be located at the one end part of its movement path when the previous execution of the cleaning mode is finished.

In the present embodiment, the cleaning holders 511 and 512 are caused to reciprocate based on their locations detected based on the ON-OFF switching of the detection portion 56, such that the cleaning holders 511 and 512 are stopped prior to touching the stoppers 62 and caused to reverse their movement directions. Instead of the configuration of the present embodiment, other methods may be adopted including one in which operation time of the motor 55 is measured and the reciprocation of the cleaning holders 511 and 512 is controlled by estimating their locations based on the measured operation time, and one in which the reciprocation of the cleaning holders 511 and 512 is controlled by detecting contact made by the cleaning holders 511 and 512 with the stoppers 62, based on a rise of current (voltage) flowing into the motor 55.

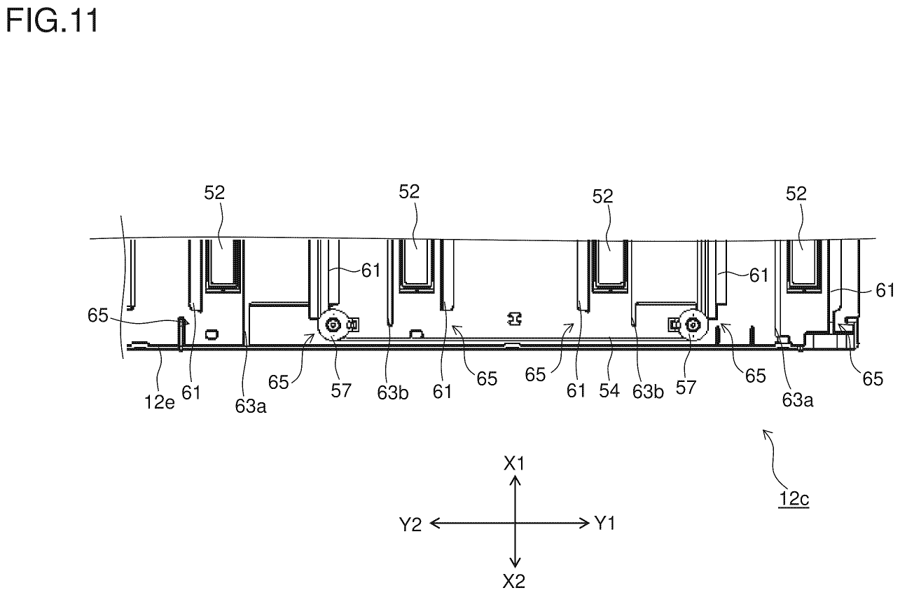

FIG. 11 is a partial plan view of one end part (on the X2 side) of the optical scanning device 12 of the present embodiment as seen from above. As shown in FIG. 11, in an extension direction (the X direction) of the first guide rails 61, the first guide rails 61 are open on the other side (the X2 side) in their extension direction. More specifically, a rib 12e is provided on a peripheral edge part of the cover portion 12c. The first guide rails 61 are not coupled to the rib 12e, such that void sections 65 are provided between the rib 12e and end parts of the first guide rails 61.

With this arrangement, by disengaging the first restriction portions 51b from the guide ribs 61a through the void sections 65, the cleaning holders 511 and 512 can be easily detached from the first guide rails 61. Further, by sliding the cleaning holders 511 and 512 toward the one side (the X1 side) in the extension direction of the first guide rails 61 while bringing the first restriction portions 51b into engagement with the guide ribs 61a through the void sections 65, the cleaning holders 511 and 512 can be easily installed on the first guide rails 61. Thus, workability is enhanced in attaching and detaching the cleaning holders 511 and 512 to and from the optical scanning device 12.

In the present embodiment, the cleaning holders 511 and 512 each include the second restriction portions 51c in contact with side surfaces of the second guide rails 63a and 63b that are formed on the cover portion 12c. Since the second guide rails 63a and 63b are in contact with the second restriction portions 51c, the cleaning holders 511 and 512 are restricted in rotation, and thus the cleaning holders 511 and 512 are held perpendicular with respect to the movement direction without a tilt. Thus, when the cleaning holders 511 and 512 stopping at an X2-side end part start to move in the first direction, it is possible to suppress the likelihood of the cleaning holders 511 and 512 snagging in the void sections 65 of the first guide rails 61, and thus to suppress occurrence of a malfunction.

Further, in the present embodiment, as shown in FIG. 11, the second guide rails 63a and 63b are formed to extend farther toward the other side (the X2 side) as compared to the first guide rails 61. More specifically, as seen from the parallel alignment direction (the Y direction), the second guide rails 63a and 63b are formed to overlap the void sections 65.

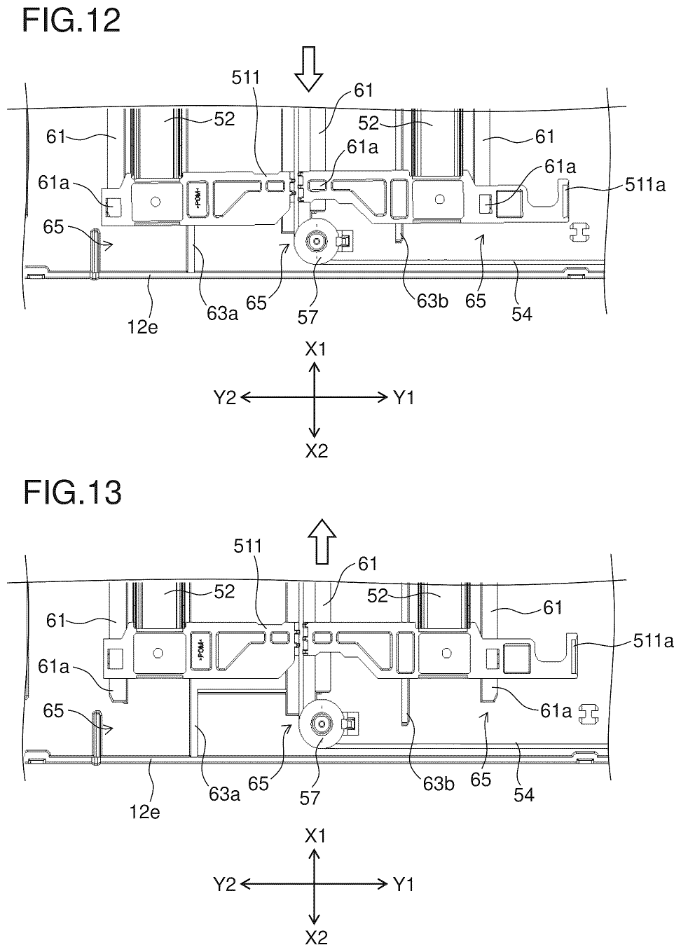

FIGS. 12 and 13 are partial plan views of the X2-side end part of the optical scanning device 12 of the present embodiment as seen from above, respectively showing a state in which the cleaning holder 511 is stopped at X2-side end parts of the first guide rails 61 and a state in which the cleaning holder 511 has started to move toward the X1 side of the first guide rails 61.

As shown in FIG. 12, in the state in which the cleaning holder 511 is stopped at the X2-side end parts of the first guide rails 61, the cleaning holder 511 partly overlaps the void sections 65. In this state, the guide ribs 61a of the first guide rails 61 and the first restriction portions 51b (see FIG. 5) of the cleaning holder 511 are maintained in an engaged state. Thus, there is no risk of the cleaning holder 511 coming off the first guide rails 61.

When the cleaning holder 511 is moved in a reverse direction (the X1 direction) from the state of FIG. 12, a pulling-direction rotational moment may act on the cleaning holder 511 to tilt it. If the cleaning holder 511 is then forced to move in the tilted state, it may become snagged on the end parts (the void sections 65) of the first guide rails 61, resulting in a malfunction.

In the present embodiment, the second guide rails 63a and 63b are formed to extend farther in the X2 direction, as compared to the first guide rails 61, so as to overlap the void sections 65. With this arrangement, even in the state shown in FIG. 12, in which the cleaning holder 511 is stopped at the X2-side end parts of the first guide rails 61, it is possible to securely maintain the state in which the second guide rails 63a and 63b are opposite to the second restriction portions 51c as seen from a direction orthogonal to the movement direction (the X direction). Thereby, the cleaning holder 511 is held perpendicular to the movement direction (the X direction) without a tilt.

Thus, when the cleaning holder 511 starts to move toward the X1 side as shown in FIG. 13, it is possible to effectively suppress snagging of the cleaning holder 511 on the end parts (the void sections 65) of the first guide rails 61, and thus to prevent occurrence of a malfunction.

As for an extent of the extension of the second guide rails 63a and 63b, as long as they are extended farther in the X2 direction as compared to the first guide rails 61 (that is, the second guide rails 63 overlap the void sections 65), a predetermined effect can be expected. However, when the cleaning holder 511 has completed its movement in the X2 direction and stopped, the second guide rails 63a and 63b need to be in contact with a corresponding one of the second restriction portions 51c. Then, when the cleaning holder 511 starts to move toward the X1 side, the contact between the second guide rails 63a and 63b and the second restriction portions 51c helps securely maintain the cleaning holder 511 in a position perpendicular to the movement direction (the X direction).

Here, the travel direction of the linear member 54 is caused to change by the pulleys 57 from the X2 direction to the X1 direction. Thus, tension of the linear member 54 acts so as to cause an outer side (a left side in FIG. 12) of the cleaning holder 511 to move more in the movement direction (the X2 direction) as compared to an inner side (a right side in FIG. 12) of the cleaning holder 511. As a result, the cleaning holder 511 becomes liable to tilt in a counterclockwise direction in FIG. 12.

To address this, in the present embodiment, the second guide rails 63a, which are positioned outside the linear member 54, are formed to extend farther in the X2 direction than the second guide rails 63b, which are positioned inside the linear member 54. Specifically, the second guide rails 63a extend to the rib 12c. This arrangement helps more effectively suppress tilting of the cleaning holder 511 caused by the tension of the linear member 54. Note that, since space needs to be secured between the second guide rails 63b and the rib 12e for the linear member 54 to pass through, the second guide rails 63b are formed at a predetermined distance from the rib 12c.

Note that the above description, which has dealt with the lengths of the second guide rails 63a and 63b which the cleaning holder 511 is in contact with, is equally applicable to the lengths of the second guide rails 63a and 63b which the cleaning holder 512 is in contact with. As shown in FIG. 8, when the cleaning holder 512 has stopped at the X2-side end part, the tension of the linear member 54 acts so as to cause an outer side (a right side in FIG. 8) of the cleaning holder 512 to move more in the movement direction (the X2 direction) as compared to an inner side (a left side in FIG. 8) of the cleaning holder 512. As a result, the cleaning holder 512 becomes liable to tilt in the clockwise direction in FIG. 8.

To address this, as shown in FIG. 11, the second guide rail 63a positioned outside the linear member 54 (that is, the one disposed at a right end in FIG. 11) is formed to extend farther in the X2 direction than the second guide rail 63b positioned inside the linear member 54 (that is, the one disposed second from the right in FIG. 11), which makes it possible to suppress tilting of the cleaning holder 512 more effectively.

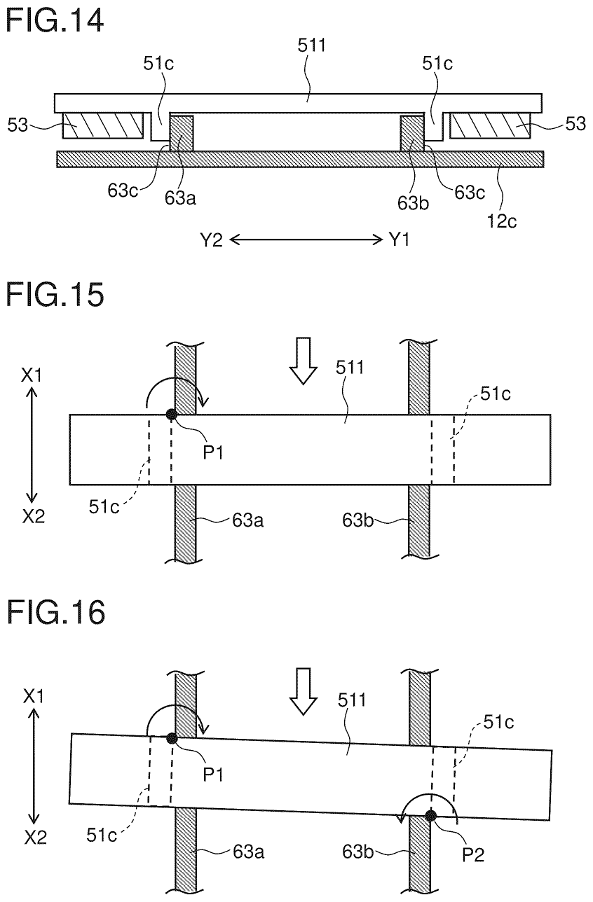

FIG. 14 is a schematic diagram showing a configuration in which the second restriction portions 51c of the cleaning holder 511 abut outer sides of the second guide rails 63. In the present embodiment, as shown in FIG. 14, the second restriction portions 51c of the cleaning holder 511 abut outer side surfaces 63c of the second guide rails 63a and 63b in a direction (the Y direction) orthogonal to the movement direction of the cleaning holder 511.

FIG. 15 is a diagram showing a state in which a clockwise rotational moment is generated about point P1 when the cleaning holder 511 is moved in the X2 direction. Let us consider a case where, for example, while the cleaning holder 511 is moved in the X2 direction, resistance acting on one side (a left side in FIG. 15) of the cleaning holder 511 in its longitudinal direction increases. In this case, a clockwise rotational moment is generated about point P1, at which the second guide rail 63a on a left side is in contact with the second restriction portion 51c on an upstream side (the X1 side) in the movement direction.

FIG. 16 is a diagram showing a state in which a counterclockwise rotational moment is generated about point P2 when the cleaning holder 511 is moved farther in the X2 direction from the state shown in FIG. 15. When the cleaning holder 511 is moved in the X2 direction from the state shown in FIG. 15, then resistance acting on the other side (a right side in FIG. 16) of the cleaning holder 511 in the longitudinal direction is increased. As a result, a counterclockwise rotational moment is generated about point P2, at which the second guide rail 63b on the right side is in contact with the second restriction portion 51c on a downstream side (the X2 side) in the movement direction.

The counterclockwise rotational moment about point P2 acts in a direction of releasing the contact, at point P1, between the second guide rail 63a on the left side and the second restriction portion 51c. Thus, even if the balance of resistance between the left and right sides is disrupted while moving the cleaning holder 511 in the X2 direction, it is unlikely for tilting of the cleaning holder 511 to cause any snagging.

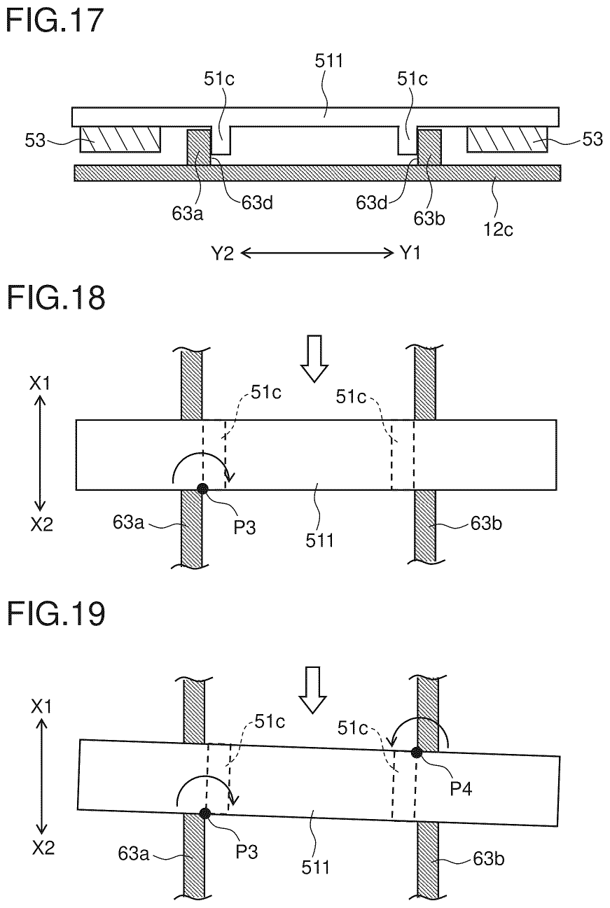

FIG. 17 is a schematic diagram showing a configuration in which the second restriction portions 51c of the cleaning holder 511 abut inner side surfaces 63d of the second guide rails 63a and 63b. FIG. 18 is a diagram showing a state in which a clockwise rotational moment is generated about point P3 when the cleaning holder 511 is moved in the X2 direction.

Let us consider a case in which, when the second restriction portions 51c of the cleaning holder 511, as shown in FIG. 17, abut the inner side surfaces 63d of the second guide rails 63a and 63b in the direction (the Y direction) orthogonal to the movement direction of the cleaning holder 511, the resistance on one side (a left side in FIG. 18) of the cleaning holder 511 in the longitudinal direction is increased while the cleaning holder 511 is moved in the X2 direction, for example.

In this case, as shown in FIG. 18, a clockwise rotational moment is generated about point P3, at which the second guide rail 63a on the left side is in contact with the second restriction portion 51c on the downstream side (the X2 side) in the movement direction.

FIG. 19 is a diagram showing a state in which a counterclockwise rotational moment is generated about point P4 when the cleaning holder 511 is moved farther in the X2 direction from the state shown in FIG. 18. When the cleaning holder 511 is moved in the X2 direction from the state shown in FIG. 18, then resistance acting on the other side (the right side in FIG. 19) of the cleaning holder 511 in the longitudinal direction is increased. As a result, a counterclockwise rotational moment is generated about point P4, at which the second guide rail 63b on the right side is in contact with the second restriction portion 51c on the upstream side (the X1 side) in the movement direction.

The counterclockwise rotational moment about point P4 does not act in a direction of releasing the contact, at point P3, between the second guide rail 63a on the left side and the second restriction portion 51c, but acts in a direction of enhancing the contact between the second guide rail 63a and the second restriction portion 51c.

That is, in the configuration in which the second restriction portions 51c of the cleaning holder 511 abut the inner side surfaces 63d of the second guide rails 63a and 63b, in a case where the balance of resistance on the cleaning holder 511 between the left and right sides is even when the cleaning holder 511 is moved, if sliding friction resistance of the cleaning holder 511 is small, there arises no problem in the movement of the cleaning holder 511. However, if the balance of resistance between the left and right sides is disrupted when moving the cleaning holder 511 or if the sliding friction resistance of the cleaning holder 511 is large, snagging is likely to be caused due to tilting of the cleaning holder 511.

As has been described hitherto, the configuration is preferable in which the second restriction portions 51c of the cleaning holder 511 abut the outer side surfaces 63c of the second guide rails 63a and 63b in the direction (the Y direction) orthogonal to the movement direction of the cleaning holder 511. Note that, although the operation of the cleaning holder 511 has been described here, the same description applies to the cleaning holder 512 as well.

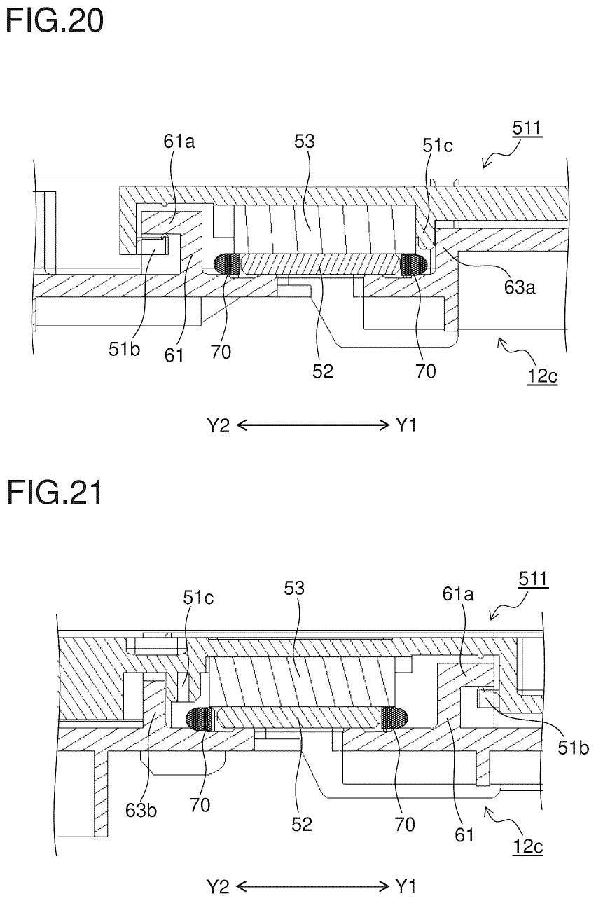

FIGS. 20 and 21 are partial enlarged views of and around the cleaning members 53 respectively disposed on one side (the left side) and the other side (the right side) of the cleaning holder 511 shown in FIG. 5. In the present embodiment, the transmissive members 52 are fixed to the cover portion 12c using a method in which end surfaces of each transmissive member 52 in a short-side direction thereof (the Y direction) orthogonal to the longitudinal direction thereof (a perpendicular direction with respect to the sheet plane of FIG. 20) is bonded with an adhesive 70, which is a UV curable resin or the like.

In this case, as shown in FIGS. 20 and 21, the adhesive 70 is cured to intervene on the end surfaces of each of the transmissive members 52 along the perpendicular direction. Here, if the second restriction portions 51c of the cleaning holder 511 extend to below the upper surfaces of the transmissive members 52, they may come into contact with the adhesive 70 during the movement of the cleaning holder 511.

If the adhesive 70 is applied in a non-continuous manner along the longitudinal direction of the transmissive members 52 so as to reduce the amount of adhesive to be used, there may be caused snagging of the second restriction portions 51c on the adhesive 70, resulting in a malfunction of the cleaning holder 511. To prevent this, in the present embodiment, the second restriction portions 51c of the cleaning holder 511 are disposed above the upper surfaces of the transmissive members 52. Thereby, it is possible to avoid contact between the second restriction portions 51c and the adhesive 70 during the movement of the cleaning holder 511, and thus to suppress occurrence of a malfunctions of the cleaning holder 511.

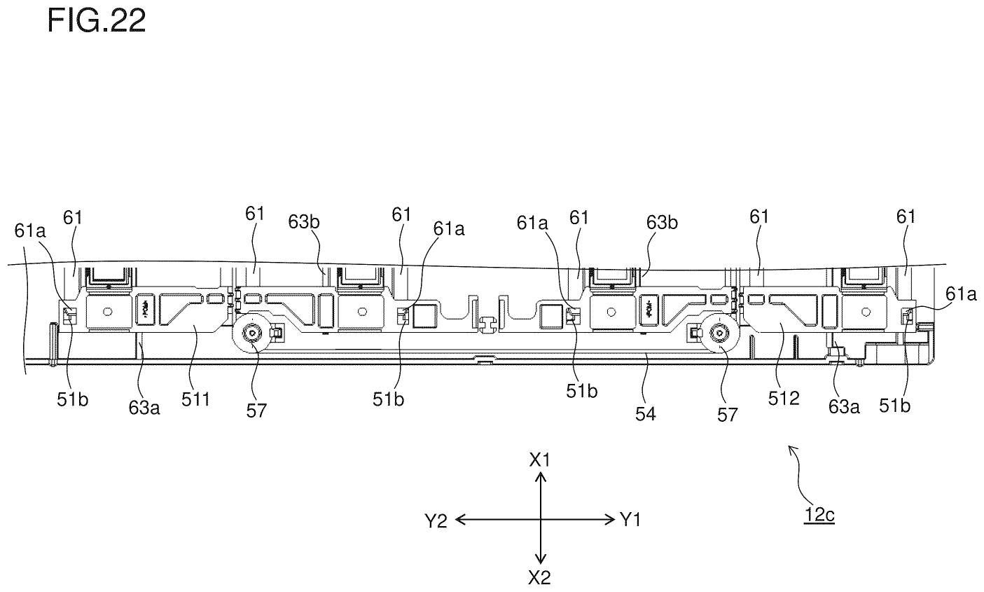

FIG. 22 is a partial plan view of the X2-side end part of the optical scanning device 12 according to the present embodiment as seen from above, showing a state in which the cleaning holders 511 and 512 have stopped at the X2-side end parts of the first guide rails 61. FIG. 22 shows a state in which the pulleys 57 on open sides of the first guide rails 61 (sides where the void sections 65 are formed) are mounted, and movement of the cleaning holders 511 and 512 in the X2 direction is restricted by the pulleys 57. In the state shown in FIG. 22, the first restriction portions 51b of the cleaning holders 511 and 512 are located at positions of engagement with the guide ribs 61a of the first guide rails 61, so that the cleaning holders 511 and 512 cannot be detached from the cover portion 12c.

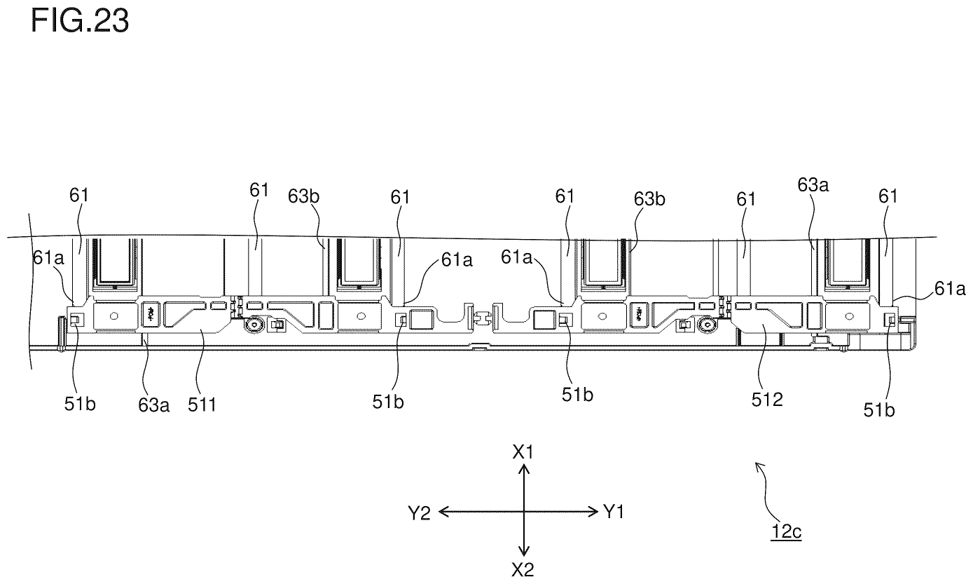

FIG. 23 shows a state in which, with the pulleys 57 detached, the cleaning holders 511 and 512 are moved in the X2 direction. In the state shown in FIG. 23, since the pulleys 57 have been detached, the cleaning holders 511 and 512 are allowed to move in the X2 direction. The first restriction portions 51b of the cleaning holders 511 and 512 are disengaged from the guide ribs 61a of the first guide rails 61, and thus the cleaning holders 511 and 512 can be detached and attached via the void sections 65.

In the present embodiment, to facilitate the attachment and detachment of the cleaning holders 511 and 512, a configuration is adopted in which the first guide rails 61 have open ends (to provide the void sections 65). However, allowing a user or the like to attach and detach the cleaning holders 511 and 512 easily is not preferable in terms of ensuring the operation of the optical scanning device 12.

Thus, in the configuration of the present embodiment, the cleaning holders 511 and 512 cannot be attached or detached without detaching the pulleys 57 on the open side (the void sections 65 side) of the first guide rails 61. That is, the pulleys 57 function as restriction members for restricting the attachment and detachment of the cleaning holders 511 and 512. This helps eliminate the risk of accidental detachment of the cleaning holders 511 and 512.

Additionally, it should be understood that the present disclosure may be practiced in any other manner than specifically described above as an embodiment, and various modifications are possible within the scope of the present disclosure. For example, in the above embodiment, a configuration has been described in which for each of the cleaning holders 511 and 512, three first guide rails 61 and two second guide rails 63a and 63b are provided; however, it is sufficient if a plurality of the first guide rails 61 and a plurality of the second guide rails 63a and 63b are provided for each of the cleaning holder 511 and 512.

Further, in the above embodiment, the optical scanning device 12 has been described that includes a pair of the cleaning holders 511 and 512 that are driven to reciprocate in mutually opposite directions by the travel of the linear member 54; however, the present disclosure is equally applicable to an optical scanning device 12 including just one cleaning holder.

Further, the above embodiment has been described with a tandem-type color printer as an example of the image forming apparatus 1 incorporating the optical scanning device 12; however, the present disclosure is not limited to color printers but is applicable to any electrophotographic image forming apparatuses provided with the optical scanning device 12, including color copiers, monochrome printers, monochrome copiers, digital multifunction peripherals, facsimile machines, and the like apparatuses.

The present disclosure is usable in optical scanning devices that form an electrostatic latent image by irradiating an image carrier with light. By using the present disclosure, it is possible to provide an optical scanning device that is capable of suppressing a malfunction of a cleaning holder that cleans a transmissive member as well as improving workability in attaching and detaching the cleaning holder, and to provide an image forming apparatus including the same.

1. An optical scanning device that irradiates an image carrier with laser light to thereby form an electrostatic latent image, the optical scanning device comprising:
a casing in which an emission port for the laser light is formed corresponding to the image carrier so as to extend in a main scanning direction of the laser light;
a transmissive member that has transmissivity with respect to the laser light, that extends in a main scanning direction of the laser light, and that seals the emission port for the laser light;
a linear member stretched in a loop on the casing;
a drive portion that drives the linear member to travel in a predetermined direction;
a plurality of first guide rails that are formed on an upper surface of the casing and that extend in an extension direction of the transmissive member;
a plurality of second guide rails that are formed on the upper surface of the casing and that extend parallel to the first guide rails;
at least one cleaning holder that is fixed to the linear member and that moves on the transmissive member along the first guide rails and the second guide rails in a first direction and in a second direction opposite to the first direction when the linear member is driven to travel by the drive portion;
a cleaning member that is fixed to the cleaning holder and that slides with respect to the transmissive member along with movement of the cleaning holder to thereby clean the transmissive member; and
a stopper that is formed at an end part of the first guide rails on a side of the first direction and that restricts movement of the cleaning holder in the first direction,
wherein
the cleaning holder includes
a first restriction portion that engages with the first guide rails in an up-down direction to thereby restrict upward movement of the cleaning holder and
a second restriction portion that is in contact with a side surface of the second guide rails to thereby restrict rotation of the cleaning holder, and
the casing includes
a rib formed along a peripheral edge part of the upper surface of the casing and
a void section that is formed between the rib and an end part of the first guide rails on a side of the second direction and that allows engagement between the first guide rails and the first restriction portion to be released therethrough.

2. The optical scanning device according to claim 1,
wherein
the second guide rails are formed to extend farther than the first guide rails in the second direction as seen from a direction orthogonal to a movement direction of the cleaning holder, and
when the cleaning holder has completed movement thereof in the second direction and stopped, the second guide rails are opposite to the second restriction portion as seen from a direction orthogonal to the movement direction.

3. The optical scanning device according to claim 2,
wherein
the linear member is fixed to a substantially central part of the cleaning holder in a longitudinal direction thereof that is orthogonal to the movement direction,
the second guide rails are formed at two positions respectively inside and outside the linear member stretched in a loop, and
among the second guide rails, a second guide rail positioned outside the linear member is formed to extend farther in the second direction than a second guide rail positioned inside the linear member.

4. The optical scanning device according to claim 1,
wherein
when the first guide rails are in engagement with the first restriction portion, a leading end of the second restriction portion is located above an upper surface of the transmissive member.

5. The optical scanning device according to claim 1,
wherein
the second guide rails include two second guide rails disposed with a predetermined distance therebetween in the longitudinal direction of the cleaning holder, and
the second restriction portion is in contact with an outer side surface of the second guide rails in the longitudinal direction.

6. The optical scanning device according to claim 1,
wherein
on the upper surface of the casing, a plurality of pulleys around which the linear member (54) is stretched are mounted close to an end part of the first guide rails on the side of the second direction, the plurality of pulleys including a detachable pulley arranged close to the void section,
with the pulley mounted on the casing, movement of the cleaning holder to a position overlapping the void section is restricted, and
by detaching the pulley from the casing and moving the cleaning holder to a position overlapping the void section, engagement between the first guide rails and the first restriction portion becomes releasable.

7. The optical scanning device according to claim 1,
wherein
the cleaning member is fixed to two positions on the cleaning holder in the longitudinal direction thereof, and
the first guide rails and the first restriction portion are arranged at three positions between which the cleaning member is disposed.

8. The optical scanning device according to claim 7,
wherein
the linear member is fixed to a substantially central part of the cleaning holder in the longitudinal direction thereof, and
the first guide rails and the first restriction portion are arranged at three positions at opposite end parts in the longitudinal direction and close to the linear member.

9. An image forming apparatus, comprising:
at least one image forming portion that includes an image carrier; and
the optical scanning device according to claim 1 that irradiates the image carrier with laser light to form an electrostatic latent image.
